(19) United States
(12) Patent Application Publication
(10) Pub. No.: US 2004/0164517 A1
(43) Pub. Date: Aug. 26, 2004

(54) Trash can trolley

(76) Inventors: Cudahy Lewy, Corvallis, MT (US); Diane E. Lewy, Corvallis, MT (US)

Correspondence Address: Richard C. Litman, LITMAN LAW OFFICES, LTD., P.O. Box 15035, Arlington, VA, 22215, US

(21) Appl. No.: 10/784,153

(22) Filed: Feb. 24, 2004

Related U.S. Application Data
(60) Provisional application No. 60/449,599, filed on Feb. 26, 2003.

(51) Int. Cl. B60D 1/145

(52) U.S. Cl. 280/493

(57) ABSTRACT

A trash can trolley utilized to tow trash cans of the conventional, single-handle, wheeled type, with or without hinged lids. In a preferred embodiment, the trolley consists of six metal pieces welded together to form a unitary body. The trolley can be easily attached to almost any common trailer hitch (car, tractor, four wheeler). The nuts, bolts, hitch pins, washers, etc. needed to secure the trolley in position are readily available at any hardware store. The trolley is capable of towing fifty and ninety gallon trashcans. The trashcan trolley requires no maintenance, except for occasional oiling to prevent rusting.

### CROSS-REFERENCE TO RELATED APPLICATION

This application claims the benefit of U.S. Provisional Patent Application Serial No. 60/449,599, filed Feb. 26, 2003.

### BACKGROUND OF THE INVENTION

1. Field of the Invention

The present invention generally relates to towing devices. More specifically, the present invention is drawn to a trolley for towing a wheeled trash can or receptacle.

2. Description of Related Art

Getting the trash can to the trash pickup point is a weekly chore that is ritualistically performed in almost all urban and suburban homes. Even with the advent of the wheeled trash can, the aforementioned chore can become arduous. This is especially true when the trash can is heavy, the homeowner is elderly or disabled, or the distance from the house to the pickup point is substantial. In such instances, it would be advantageous to have a simple device that could be utilized to tow the trash can behind the family automobile, pickup truck, SUV or a garden tractor.

The prior art is replete with devices for towing wheeled trash cans. For example U.S. Pat. Nos. 6,033,178 and 6,164 896 (both to Cummins) show devices for transporting wheeled trash cans. It is noted, however, that the devices are utilized to lift the trash can from the ground. Furthermore, the devices employ several moving parts, which parts are subject to wear and malfunction.

U.S. Pat. No. 5,711,543 (Stokes), U.S. Pat. No. 6,203,032 B1 (Ramos) and U.S. Pat. No. 6,309,167 (McPherrin) disclose towing assemblies which employ a relatively intricate system for attachment to a towing vehicle and as in the art cited above, all include a number of moving parts which are subject to wear and would need replacing.

U.S. Pat. No. 3,237,968 (Arsenault) is drawn to structure for towing wheeled golf carts. The disclosed structure is not suitable for towing conventional wheeled trash cans.

U.S. Pat. 6,379,099 B1 (Novak) discloses apparatus for lifting and rotating garbage dumpsters. The patentee does not contemplate providing any structure to tow the dumpster.

None of the above inventions and patents, taken either singly or in combination, is seen to disclose a durable and trash can trolley of simple and economical construction, as will subsequently be described and claimed in the present invention.

### SUMMARY OF THE INVENTION

The instant invention is drawn to a device dubbed “The Trash Can Trolley”, which is utilized to tow trash cans. The trash cans are of the conventional, single-handle, wheeled type, with or without hinged lids. In a preferred embodiment, the trolley consists of six metal pieces welded together to form a unitary body. The trolley can be easily attached to almost any common trailer hitch (car, tractor, pickup truck, SUV four-wheeler). In normal conditions, the time for such attachment is only a couple of minutes. The nuts, bolts, hitch pins, washers, etc. needed to secure the trolley in position are readily available at any hardware store. The trolley is capable of towing fifty and ninety gallon trash cans. It has been determined that the maximum safe speed for towing, when using the trolley in normal conditions, is about six miles per hour. More care should be taken if road and weather conditions are difficult. The user must be careful not to operate the towing vehicle in reverse, as such operation may function to dislodge the trash can from the trolley. The trash can trolley requires no maintenance, except occasional oiling to prevent rusting. A bungee cord may be employed to secure the trash can to the trolley if necessary.

Accordingly, it is a principal object of the invention to provide a towing device for a wheeled trash receptacle.

It is another object of the invention to provide a towing device for a wheeled trash receptacle, which device can be quickly and easily mounted to a towing vehicle.

It is a further object of the invention to provide a towing device for a wheeled trash receptacle, which device is of rugged one-piece construction and substantially maintenance free.

Still another object of the invention is to provide a towing device for a wheeled trash receptacle, which device can be utilized with various standard-sized, wheeled trash receptacles.

It is an object of the invention to provide improved elements and arrangements thereof in a device for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a first embodiment of a trash can trolley according to the present invention.

FIG. 2 is a perspective view of a first embodiment of a trash can trolley according to the present invention.

FIG. 3 is an environmental, perspective view of a second embodiment of a trash can trolley according to the present invention.

FIG. 4 is a perspective view of a second embodiment of a trash can trolley according to the present invention.

Similar reference characters denote corresponding features consistently throughout the attached drawings.

### DETAILED DESCRIPTION OF THE PREFERRED EMBODIMENTS

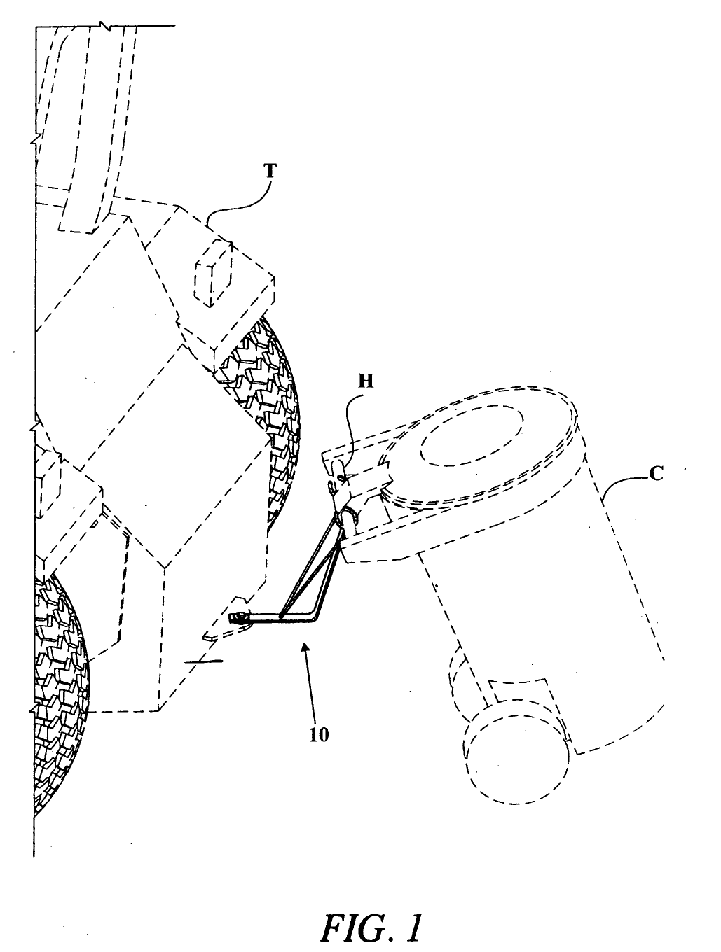

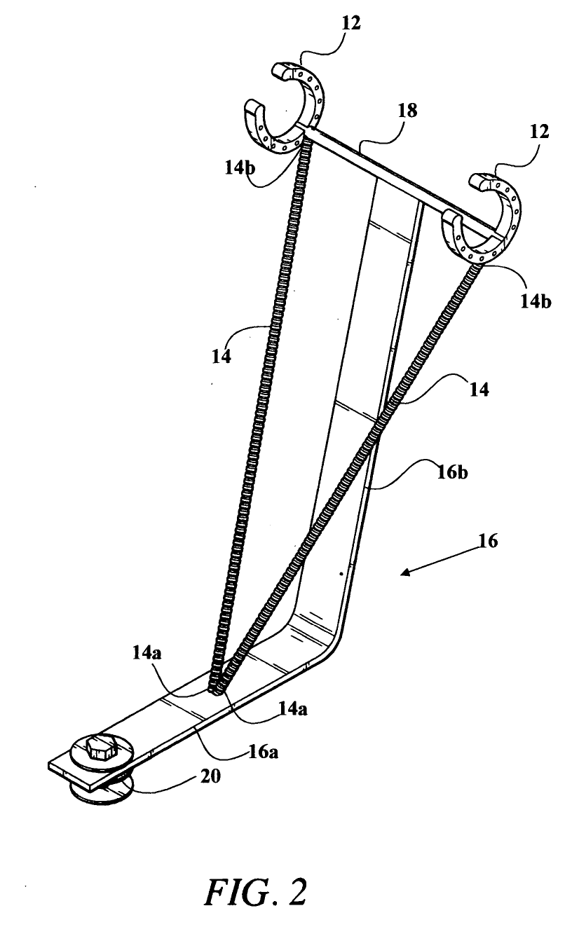

Attention is first directed to FIGS. 1 and 2 wherein the trash can trolley of the present invention is generally indicated at 10. Trolley 10 is mounted at one end to the hitch of a towing vehicle T. The other end of the trolley is adapted to engage the handle H of a wheeled trashcan C.

As best seen in FIG. 2, trolley 10 consists of a main body part 16 fabricated from a 1¾″ wide by ⅜″ thick metal bar. The bar is bent to form an obtuse interior angle of approximately one-hundred-twenty-two degrees. Leg 16a of body part 16 is approximately ten inches long. Leg 16b is approximately twenty inches long. (Clearly, other sizes and dimensions of parts just described may be used, all within the ambit of the present invention.) An opening (not shown) is formed in the end of leg 16a for receiving nuts, bolts and washers 20 for attaching the trolley to the hitch of the towing vehicle. Of course, a pintle, latch or spring-loaded pin, or any other attachment suitable for the purpose just described could be used. A pair of struts 14 are provided with proximate ends 14a, which ends 14a are welded to leg 16a. Struts 14 extend angularly from leg 16a and terminate in ends 14b, which ends are welded to a metal stop 18, which extends transversely across the end of leg 16b. Horseshoe-shaped metal members 12 are welded to each end of stop 18.

In use, as shown in FIG. 1, leg 16a is attached to the hitch of vehicle T. Body member 16 is maneuvered so that horseshoe-shaped members 12 are positioned to engage handle H of trashcan C.

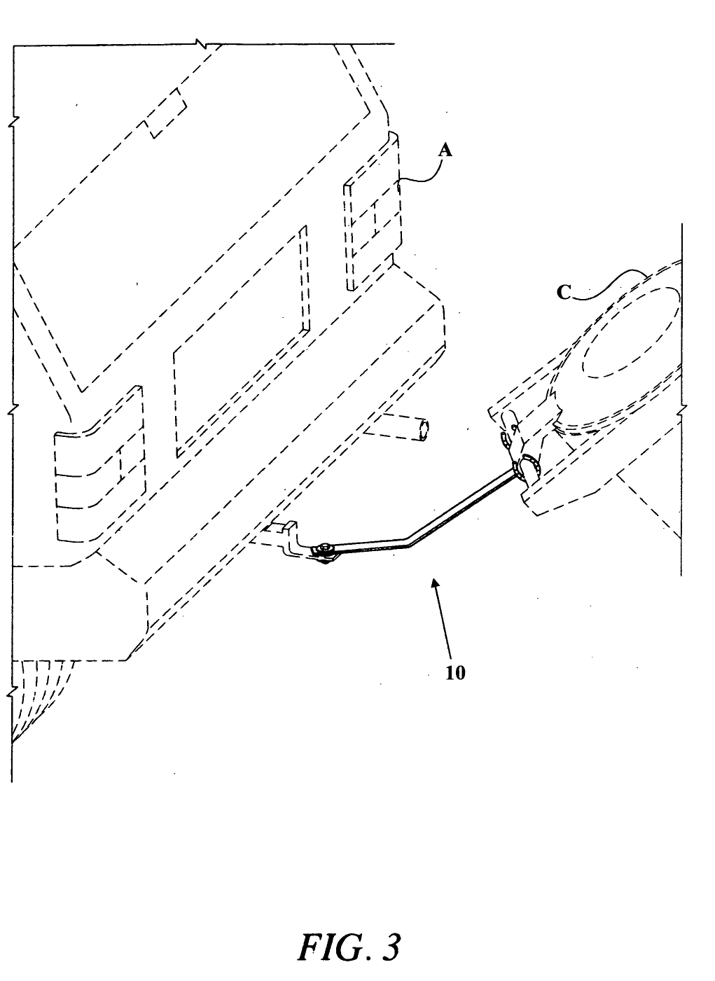

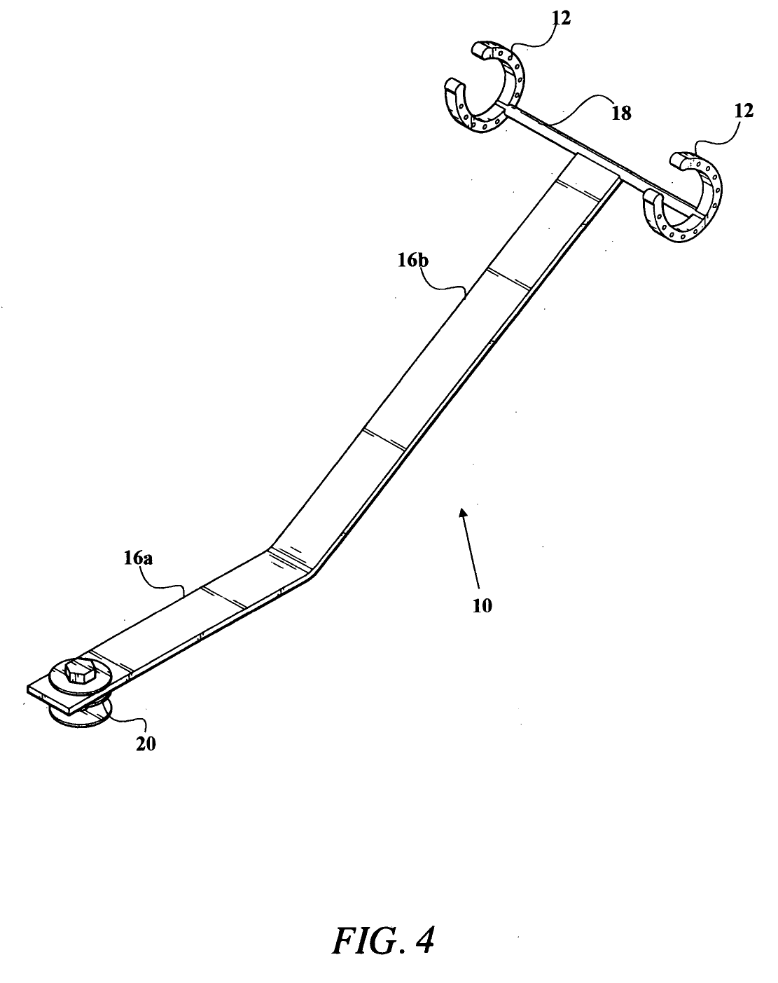

The embodiment of trolley 10 as illustrated in FIGS. 3 and 4 is similar to that of FIGS. 1 and 2, except that the struts 14 have been eliminated. The first embodiment is more suitable if attached to the hitch of a tractor, whereas the second embodiment is more adaptable to the hitch of an automobile A, or pickup truck, SUV, truck, etc.

It is to be understood that the present invention is not limited to the embodiments described above, but encompasses any and all embodiments within the scope of the following claims.

We claim:

1. A trash can towing device comprising:
a body member, said body member having a first end and a second end;
means disposed on said first end for attaching said body member to a hitch of a towing vehicle; and
a pair of horseshoe-shaped members, said pair of horseshoe-shaped members disposed on said second end for detachable engagement with the trashcan.

2. The trashcan towing device according to claim 1, wherein said body member is bent to form an obtuse angle between said first end and said second end.

3. The trash can towing device according to claim 2, further comprising a stop member across said second end of said body member, said stop member having outer ends, said horseshoe-shaped members mounted on said stop member outer ends.

4. The trash can towing device according to claim 3, further comprising strengthening struts extending from said body member adjacent said first end to said outer ends of said stop member.

5. The trash can towing device according to claim 1, further comprising a stop member across said second end of said body member, said stop member having outer ends, said horseshoe-shaped members mounted on said stop member outer ends.

6. A trash can towing device comprising:
a body member, said body member having a first end and a second end, said body member bent to form an obtuse angle between said first end and said second end;
means disposed on said first end for attaching said body member to a hitch of a towing vehicle; and
a pair of horseshoe-shaped members, said pair of horseshoe-shaped members disposed on said second end for detachable engagement with the trashcan.

7. A trash can towing device comprising:
a body member, said body member having a first end and a second end, said body member bent to form an obtuse angle between said first end and said second end;
means disposed on said first end for attaching said body member to a hitch of a towing vehicle;
a stop member across said second end of said body member, said stop member having outer ends, said horseshoe-shaped members mounted on said stop member outer ends; and
a pair of horseshoe-shaped members, said pair of horseshoe-shaped members disposed on said second end for detachable engagement with the trashcan.

8. The trash can towing device according to claim 7, further comprising strengthening struts extending from said body member adjacent said first end to said outer ends of said stop member.
